(19) United States
(12) Patent Application Publication
(10) Pub. No.: US 2006/0064410 A1
(43) Pub. Date: Mar. 23, 2006

(54) System and method for providing an exit window on a user display device

(76) Inventors: Anne Marie Razza, Villa Park, IL (US); John Bekas JR., Chicago, IL (US); Brian Zimmer, Chicago, IL (US); David P. Thomas, Chicago, IL (US); Gillian Jetson Tarinelli, Naperville, IL (US); Brent E. Walker, Chesterton, IN (US); Brian C. Leach, Orland Park, IL (US)

Correspondence Address: WILDMAN HARROLD ALLEN & DIXON, 225 WEST WACKER DRIVE, SUITE 2800, CHICAGO, IL, 60606, US

(21) Appl. No.: 11/230,834

(22) Filed: Sep. 20, 2005

Related U.S. Application Data
(60) Provisional application No. 60/611,529, filed on Sep. 20, 2004.

(51) Int. Cl. G06F 17/30

(52) U.S. Cl. 707/3

(57) ABSTRACT

A system and method of automatically creating a window for display on a display device coupled with a user computer are provided. An application server of the system receives search criteria inputted through user interaction at a user computer displaying web pages of a particular website. The system determines that the website may be exited from the user computer. An exit window having information related to the search criteria is launched for display in response to the determination that the website is being exited.

### CROSS REFERENCE TO RELATED APPLICATION

This application claims priority from U.S. Provisional Application No. 60/611,529 filed on Sep. 20, 2004.

### FIELD OF THE INVENTION

This present invention relates to systems and methods for launching windows for display on display devices upon user interaction with automated searching systems.

### BACKGROUND OF THE INVENTION

Obtaining product information such as product price and availability information as a result of performing on-line searches with one or more search engine systems is rapidly becoming a common practice for Internet users. The Internet allows consumers to access vast amounts of data regarding the products and services offered by many different providers. For example, travel-related products such as airline flights, hotel accommodations and automotive rentals are being searched for and purchased more and more through travel-related websites via the Internet.

When performing an on-line search for a particular product or service, the consumer often enters particular search criteria related to the product or service through an Internet-based website displayed at a user computer that communicates with a search engine system. For instance, searching for travel-related products often requires the consumer to input desired travel dates and times and pricing information. The type and specificity of the inputted search criteria may selectively vary based on the particular needs of the consumer and/or the features of the search engine system.

In some instances, the consumer may be in a “looking” mode and may conduct a search to perform comparison-shopping through the Internet. A consumer may also become temporarily distracted and redirect the web browser during the search session to another website. In conventional systems, the search criteria inputted by the consumer and the search results may be lost under these circumstances. When the consumer returns back to the website, the consumer must start the search process over again and is often required to re-enter the desired search criteria. Therefore, a need exists to allow consumers to efficiently search for products and services when returning back to a previously exited website by providing immediate access to the website and current results for the product(s) searched.

### BRIEF DESCRIPTION OF THE DRAWINGS

FIG. 1 is an exemplary diagram of a computer implemented system for automatically creating a window for display on user computer.

FIG. 2 is a process flow diagram of the exit application process when implemented from a search page of a travel-related search engine.

FIG. 3 is a process flow diagram of the exit application process when implemented from a booking page of a travel-related search engine.

FIG. 4 is an exemplary screen capture of a search exit window.

FIG. 5 is an exemplary screen capture of a booking exit window.

FIG. 6 is an exemplary screen capture of a travel-related search engine displaying flight search results of a search results page.

FIG. 7 is an exemplary screen capture of a travel-related booking engine displaying a flight booking page.

FIGS. 8A-J are examples of cross-sell product deals that can be displayed in the exit windows.

FIG. 9 is an exemplary screen capture of an email address input screen.

FIG. 10 is an exemplary email sent from the search exit window regarding a travel search.

FIG. 11 is an exemplary email sent from the booking exit window regarding a flight selection.

FIG. 12 is an exemplary screen capture associated with a travel-related search engine displaying flight and hotel package search results.

FIG. 13A is a process flow diagram of a search tracking process.

FIG. 13B is a process flow diagram of a search tracking process employed for use in a membership based service.

FIG. 14 is an exemplary screen capture of an interactive tracking display.

FIG. 15 is an exemplary screen capture of a member check display.

FIG. 16 is an exemplary screen capture of a member creation display.

### DETAILED DESCRIPTION

A computer implemented system for automatically creating a window for display on a display device coupled with a user computer is provided. An application server of the system receives search criteria inputted by a user at the user computer upon the user interacting with a website associated with the application server. The application server interacts with a network server and provides web pages of the website for display at the display device. For instance, the application server initiates product searches and provides for the display of search results on a search results web page. An exit window application component associated with the application server provides coding included as part of certain web pages of the website. In particular, the exit window application component contains code associated with the website web pages that provides for the launching of an exit window having information related to the search criteria for display on the user computer in response to a determination that the website is being exited by the user. In one example, information related to the last search criteria received from the user computer is saved in a code associated with the exit window. If the user selects a designated selectable return link (such as a hypertext link, button or other actuatable link or graphic) in the exit window being displayed, an instruction is sent from the browser of the user computer and is received by an exit window application component associated with the application server which prompts the coding associated with exit window application component to close the exit window. For example, coding associated with the exit application component is provided to the user computer. The user computer transmits data for recreating the search back to the exit window application component associated with the application server. A browser at the user computer then may close the exit window. Search results based on information related to the search criteria saved in the code associated with the exit window may then be displayed to the user in a search results window that is then launched. In some examples, a search may be executed directly from code associated with the exit window and interaction with the application server may alternatively take place to permit booking or other product purchasing to be made via the user computer. The search criteria, for example, may be for a travel-related product such as airline flights, hotel accommodations, car rentals, vacation packages, or travel purchases.

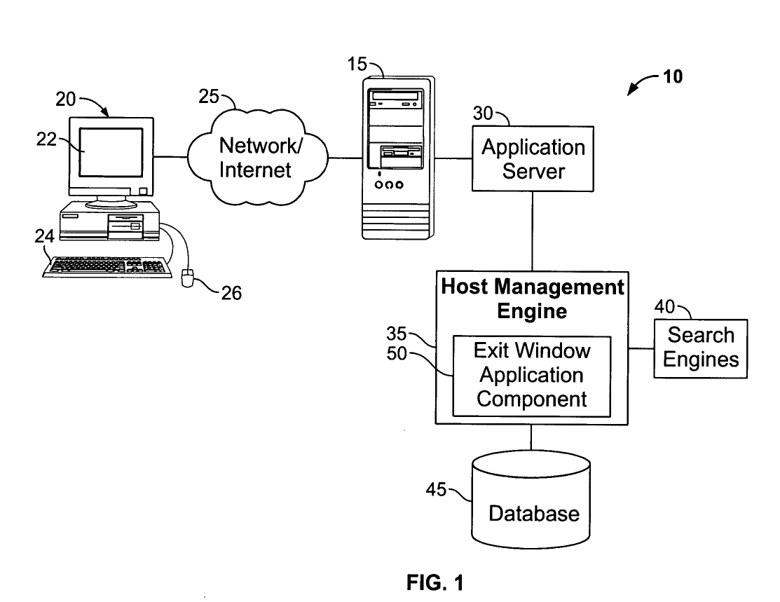

FIG. 1 illustrates a computer implemented system (indicated generally at 10) that is employed to run an exit window application associated with a travel-related search engine, which is described in more detail below. The system comprises a network server 15 that is coupled to a user computer 20 through a network 25. The network server 15 is also coupled to a computer controlled application server 30, for instance through a LAN (local area network). Alternatively, a single server could be used that performs the functions of the network server 15 and application server 30. A host management engine 35 runs on the application server 30 and is used to receive and process inquires and provide results based on the inquiries. The host management engine 35 can access various search engines 40, such as a flight search engine, hotel search engine, car rental search engine, and the like, coupled with the application server 30, to process travel-related inquiries. In addition, the host management engine 35 can access a database 45 coupled with the application server 30 for storage and retrieval of information such as travel itineraries, membership data, traveler data, and the like. The host management engine 35 of application server 30 contains code for the provision of various web pages of the website. The host management engine 35 has a computer software based exit window application component 50 that provides software code for web pages of the website associated with the application server 30 and interacts with information received in relation to an exit window described below. In this embodiment, the host management engine 35 resides on the application server 30. However, the host management engine 35 may alternatively be implemented apart from the application server 30.

The network server 15 is a dedicated web server adapted to provide a network interface between the user computer 20 and the application server 30. The network server 15 serves web pages to the user computer 20, which are displayed for the user by a web browser on the user computer 20. The network server 15 also receives input data entered by the user through the user computer 20 and transmitted to the network server 15 over the network 25. Much of the content displayed in the various web pages sent to the user computer 20 from the network server 15 is generated by the system 10 based on communications between the network server 15 and the user computer 20. However, the processing for generating the content and for carrying out instructions entered by the user is performed by the application server 30, which is transparent to the user.

The network 25 could be the Internet, a LAN (local area network), a WAN (wide area network), a dial-up connection, or any other communications network. The user computer 20 could be a desktop computer, laptop computer, workstation, PDA (personal digital assistant) or any other computing device that would allow a user to connect to the network server 15 through the network 25. In addition, the user computer 20 has a display device 22, such as a monitor or screen, and one or more input devices, such as a keyboard/keypad 24 or mouse 26. The application server 30 acts as an interpreter between the network environment of the network server 15 and the user computer 20, and the back end systems (such as the host management engine 35, search engines 40, and database 45), which carry out the searches and the booking processes.

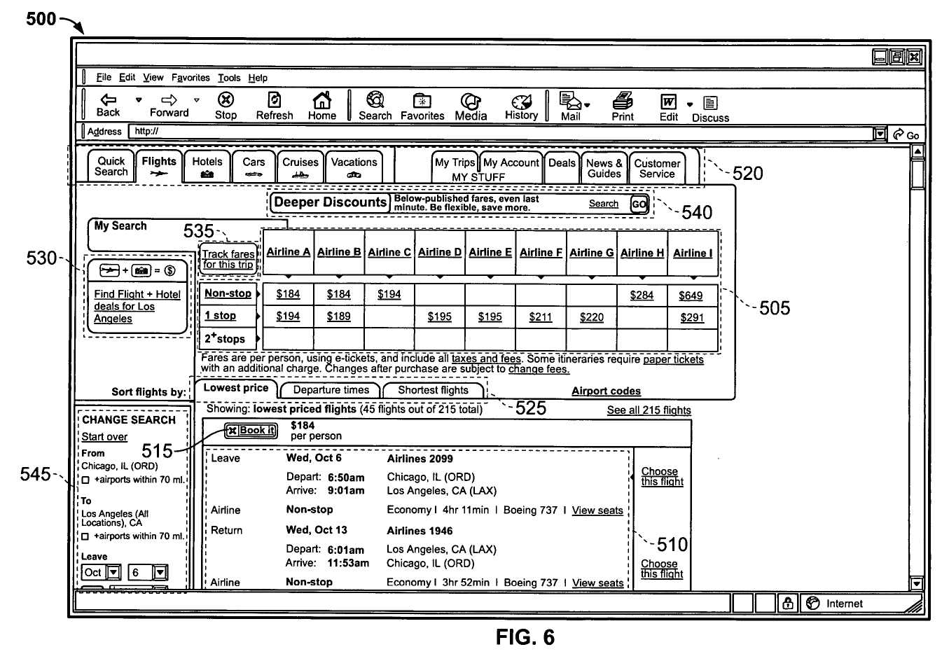

The user computer 20 receives input commands and data from a user and interacts with the network server 15 via the network 25. The network server 15 is adapted to send web pages to and receive requests and data from the user computer 20. The web pages sent to the user computer 20 by the network server 15 are displayed on the user computer 20, such as on a monitor or other display device 22. The network server 15 receives data entered at the web pages by the user via one or more input devices 24, 26 and forwards the data to the application server 30. The application server 30 formulates queries based on the data entered by the user and sends the queries to the search engine 40, which searches the database 45 for travel product information such as itineraries and their associated rates or fares that meet the inputted search criteria of the user. Search engine 40 and database 45 communicate via host management engine 35. When a search is complete, the search engine 40 forwards the search results to the application server 30, which generates a search results page (e.g. as seen in FIG. 6) that the network server 15 sends to the user computer 20 via the network 25, where the results are displayed for the user.

As described herein, a user computer 20 is connected to the network server 15 of the system via the Internet and employs a web browser to access a website associated with the application server 30. In addition, the application server 30, having exit window application component 50, is described herein as it would be used with a travel-related search engine, such as one where a user can search for various travel-related products (e.g. flights, hotels, car rentals, travel packages etc.) and book the travel-related products if desired. However, it will be understood by those skilled in the art that the system used could be any system of the type described above and the exit window application component could be adapted and used in connection with any type of search engine where it would be desired to launch and display an exit window having a selectable return member that would allow a user to go back to the results of a previous search without having to re-enter the search criteria.

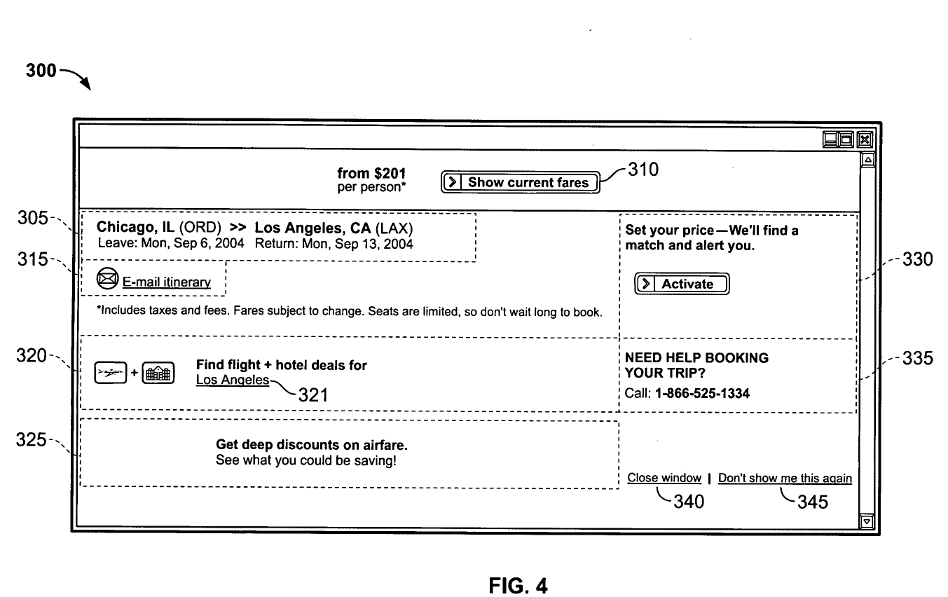

In a first example, user computer 20 having a web browser is employed to access a travel-related site through the network 25. The travel-related site is associated with at least one search engine 40 that is coupled to application server 30 and the user requests a search for flights by entering certain search criteria, such as a departure location, a destination, dates of travel, etc. The search request and inputted search criteria are communicated to the host management engine 35 residing on application server 30, which then performs a search using the search engines 40. The results of the search performed are then communicated from the host management engine 35 to the user computer 20 and displayed in a search results page 500 (see FIG. 6) on the display device 22 of the user computer 20, FIG. 1. If the user attempts to leave the travel-related site at any time during the search process, such as by entering a new URL (Universal Resource Locator), selecting a favorites link (or other link to an external website), or closing their web browser, a search exit window (see FIG. 4) is launched and displayed.

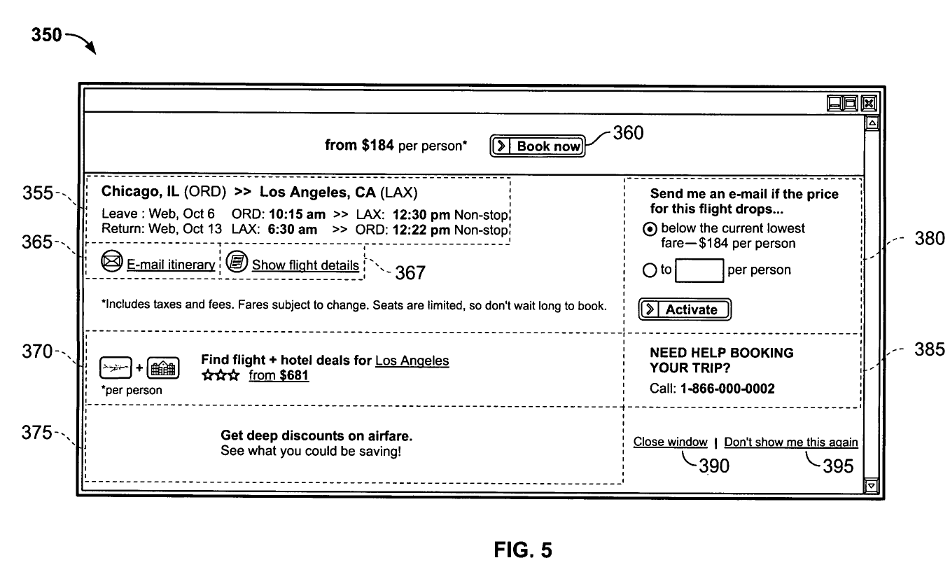

The system determines if the user computer 20 is exiting the website associated with the application server 30. In particular, a command from the browser running on the user computer 20 is sent in response to determining: (a) that a new URL has been entered at the user computer, (b) that a link to an external website has been selected, or (c) that a browser window associated with the website has been closed. An exit window having information related to the last search run by the user is launched for display at the user computer in response to the determination. An exit window, for example, may be a “pop-under” type window that is automatically launched underneath (behind) a web page in another window being displayed at a display device in response to potential exiting of a website. See FIGS. 4 and 5. As an alternative, the exit window may be a “pop-up” type window appearing in response to potential exiting of a website. A search exit window (FIG. 4) relates to an exit window that is launched if a user leaves a search segment of the travel-related website, while a booking exit window (FIG. 5) relates to exiting of a booking segment of the travel-related website.

To determine if a user computer 20 is exiting the travel-related website, and therefore to determine whether to launch a search exit window, the web pages of the travel-related site are coded to be set to launch a search exit window 300, FIG. 4, upon receipt of an UNLOAD command from the browser window. If a user enters a new URL at the user computer, selects a link external to the website, or closes the browser window associated with the website, an UNLOAD command will be received by the exit window application component, and a search exit window (e.g. see FIG. 4) is opened, which contains in its code information related to the search criteria for the last run search. The exit window stays active until one of the following occurs: (a) a timeout value is reached (e.g. 60 minutes, however, this is configurable), (b) user has clicked a specific link to return to the website that opens a new window, (c) the customer has selected an option to never see the exit window pop-up again, or (d) the customer has closed the exit window. For instance, the exit window is deactivated when a timeout value is reached.

The browser window will also issue an UNLOAD command if a user clicks on an internal link, clicks the browser back button, or clicks the browser reload/refresh button, at which time the search exit window will also be launched. However, when these actions occur, the user is still using the travel-related website and the search exit window should not be launched. The display of the exit window is prevented upon a determination that the website has not been exited. To prevent this display of the exit window, two techniques are used in this example.

First, each internal link on the travel-related website is coded to set a variable that indicates that an internal link is being followed. Each web page of the search portion of the travel-related website may be coded to check this variable prior to launching the search exit window. If this variable is TRUE, then the search exit window will not be launched.

Second, each web page of the travel-related website may selectively be programmed to close the search exit window when one of the web pages of the website is loaded. Therefore, although the search exit window will be launched when one web page of the travel-related site is left, if the new web page is still at the travel-related website, the search exit window will automatically be closed. To close a search exit window opened in this manner, a new window is launched of small size in the corner of the screen that has an identical window name to that of the search exit window. This matching name causes the search exit window to be replaced by the new window that the travel-related website launched. Once this is done, the close event of the new window is called by the travel-related website.

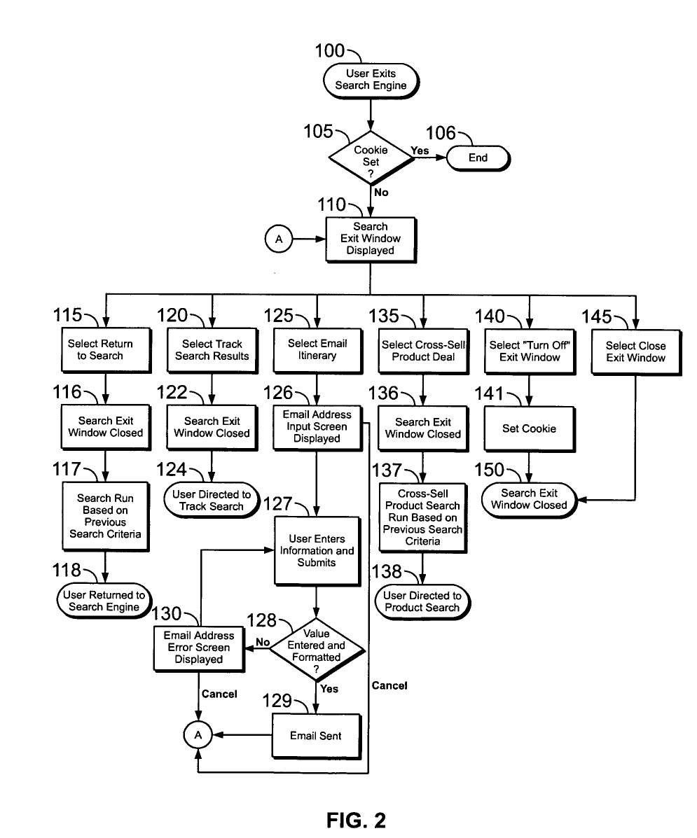

FIG. 2 illustrates how the exit application associated with the exit window application component operates once it has been determined that the user is exiting a search performed on the travel-related website. In particular, the example described in FIG. 2 relates to the processing performed upon a user leaving the website after inputting search criteria for an airfare search. As shown in FIG. 2, at step 100 the user exits the search engine 40 associated with the travel-related site. Once the user exits the search related site, at step 105 the exit application launches and checks if a “Do Not Show” cookie is present on the user computer 20. If this cookie is present, the search exit window is not displayed and the process ends at step 106. If this cookie is not present on the user computer 20, at step 110 the search exit window is launched on the user computer, the last search criteria is coded into the search exit window code, and the search exit window is directed to a specific web page located on the application server 30 and displayed on the display device 22 of the user computer 20 (see FIG. 4).

In the search exit window 300, the user is presented with various information and actuatable members such as various links, which are shown in FIG. 4 and described in detail below. Depending on the link, or other actuatable member button selected by the user, different actions are taken and functions are performed.

At step 115, FIG. 2, the user selects to return to the search results and view the current fares for the flights found in the search. Once selected, at step 116 the search exit window 300 (FIG.4) is closed. At step 117 the search is then re-run on the application server 30 coupled with search engines 40 using the search criteria saved from the earlier search, which is saved in code of the search exit window. At step 118 a new search results window is launched, that is directed to the search engine 40 on the travel-related website, and the search results are displayed in a search results page 500 of a search results window. (e.g. See FIG. 6).

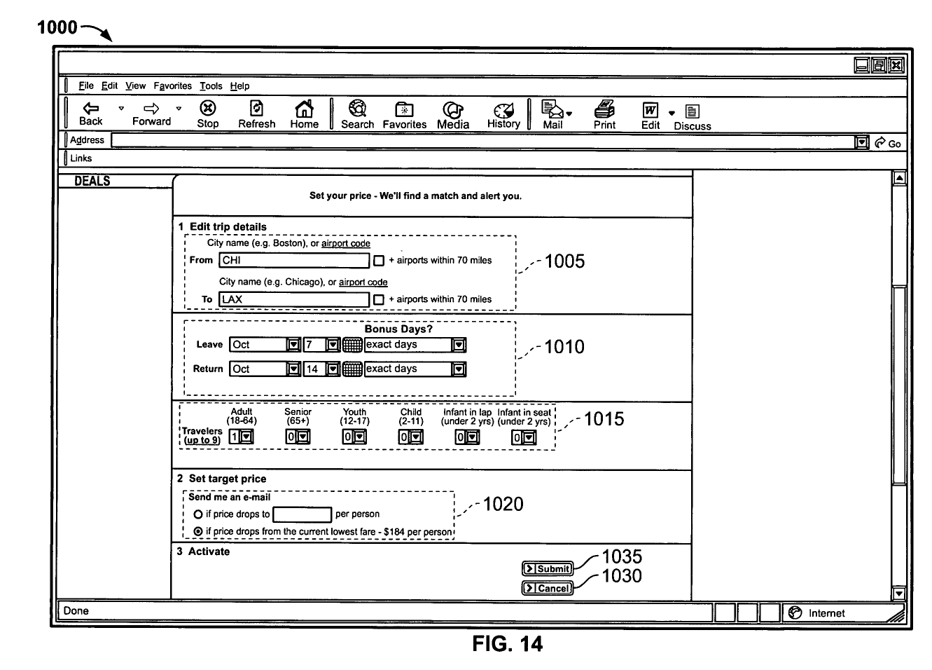

At step 120, the user selects to track the search results found in the search. This allows the user to request to be notified if a flight becomes available that satisfies the search criteria and has a price that either is below the current price or below a price set by the user. Once selected, at step 122 the search exit window is closed. At step 124 a new window is launched, is directed to a track search page on the travel-related website, and the track search page is displayed in the new window (see FIG. 14).

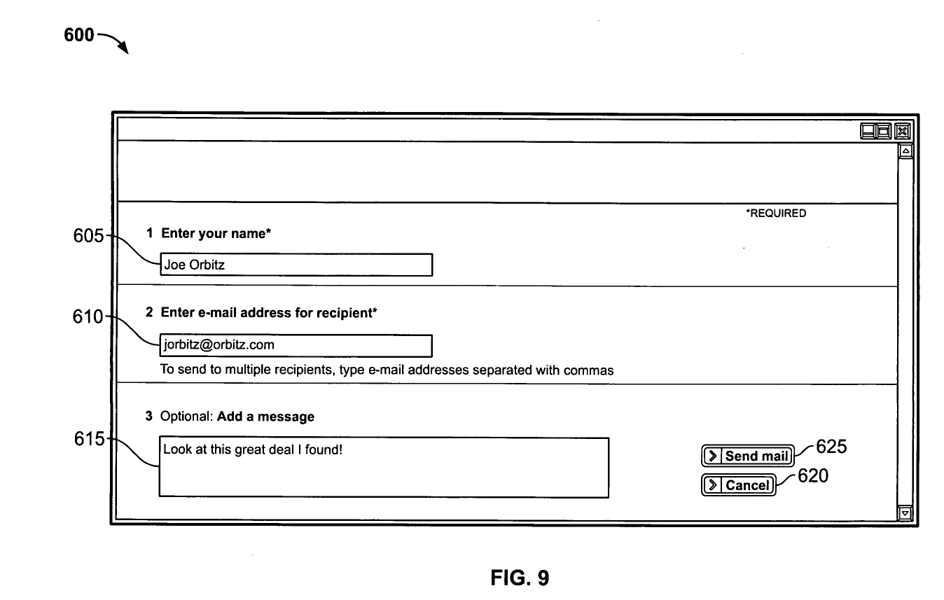

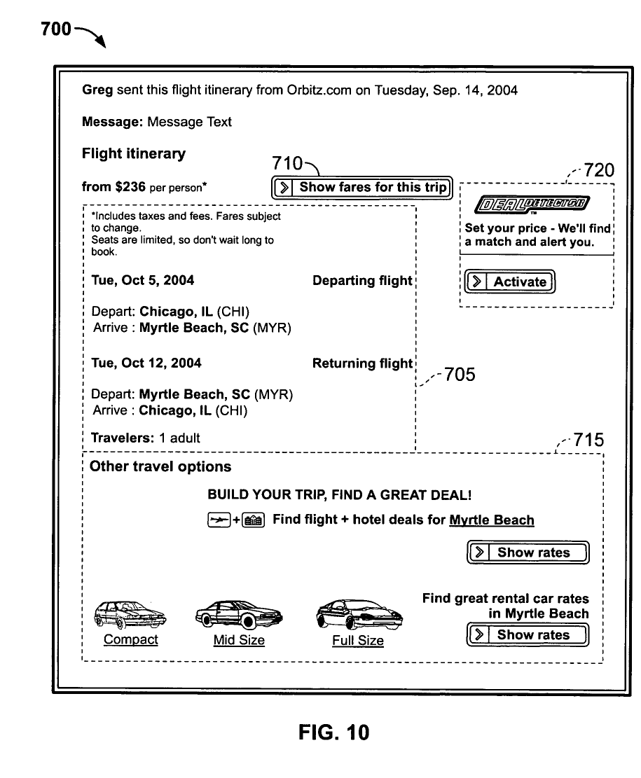

At step 125, the user selects to email the itinerary (from the search performed) to others. Once selected, at step 126 an email address input screen (see FIG. 9) is displayed in the search exit window 300, FIG. 4. If the user changes their mind, they can cancel out of the email address input screen at which time the search exit screen would again be displayed in the search exit window. If the user does not cancel out of the email address input screen, the user enters the information required in the email address input screen and submits the information at step 127. This information is sent to the application server 30 and at step 128 it is determined if a value has been entered into each required field and if the values are formatted correctly. If values have been entered into each required field and the values are formatted correctly, at step 129 an email is sent by the application server (see FIG. 10) and the search exit page is again displayed in the search exit window 300, FIG. 4. If values are not entered into each required field or values are formatted incorrectly, at step 130 an email address error screen is displayed in the search exit window and the user is requested to enter the missing values or correct or re-enter the incorrectly formatted values, at which point the user would again cancel or enter and submit the values (step 127).

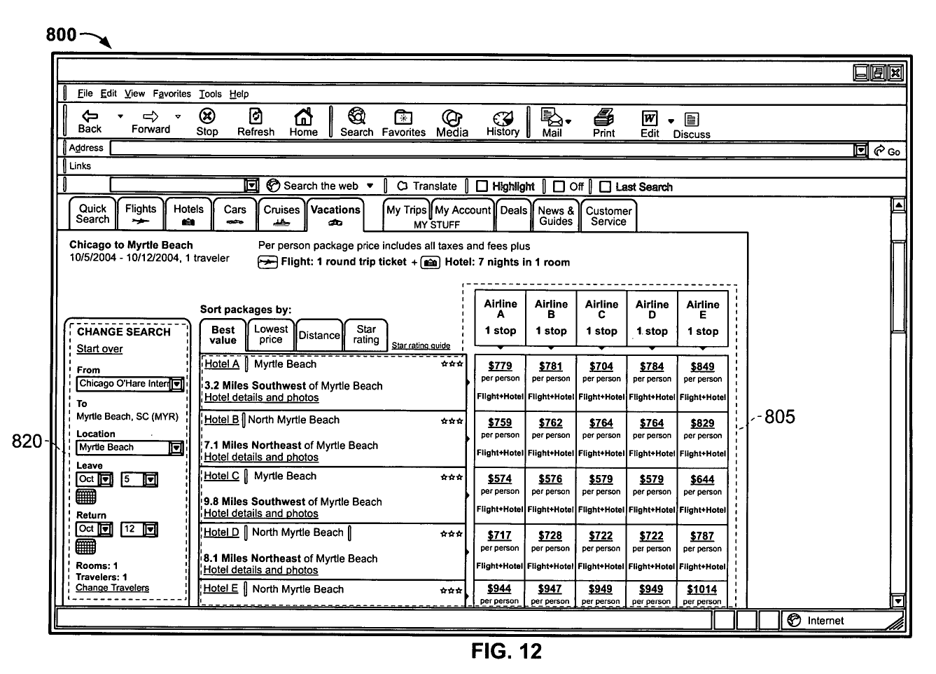

At step 135, the user selects a cross-sell product deal, which allows the user to view results for other travel-related products, such as hotel accommodations, car rentals, packages, etc., based on the original search criteria. Once selected, at step 136 the search exit window is closed. At step 137, a search is run on the application server 30 for the cross-sell product using the search criteria saved from the earlier search, which is saved in the code of the search exit window. At step 138, a new window is launched, is directed to the travel-related site, and the cross-sell product search results are displayed in the new window (see FIG. 12 for an example of cross-sell for vacation package).

At step 140, the user selects to “turn off” the search exit window, which allows the user to prevent the search exit window from appearing in the future when the user exits the travel-related website for any reason. Once selected, at step 141, a “Do not show” cookie is set on the user computer with instructions not to launch the search exit window in the future (see step 105 above). The search exit window is then closed at step 150. At step 145, the user selects to close the search exit window, which closes the search exit window at step 150.

In a second example, the user uses the web browser on the user computer 20 to access the travel-related website through the network 25, requests a search for flights and receives the search results, and makes a flight selection.

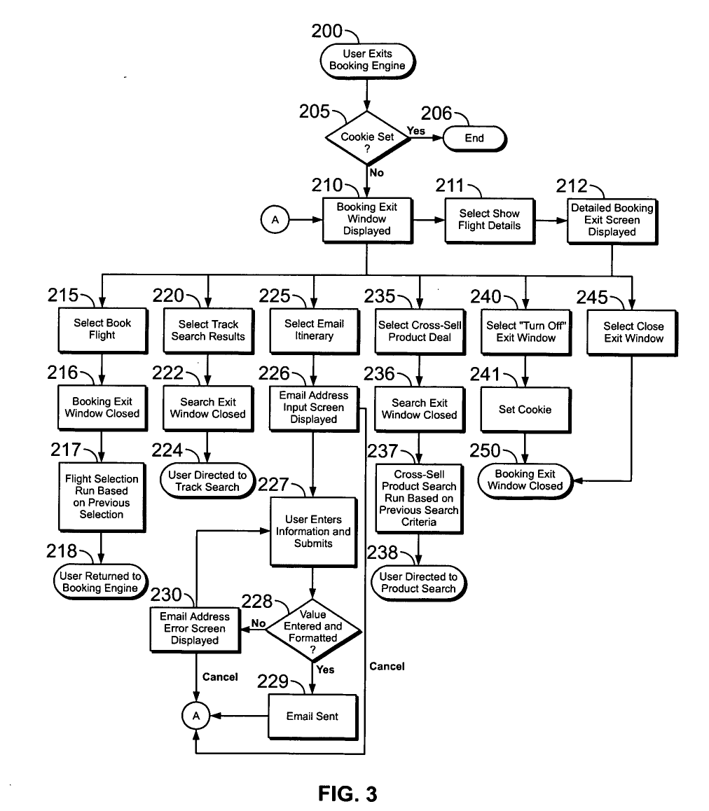

FIG. 3 illustrates how the exit application interacting with the application server 30 operates once it has been determined that the user has made a flight selection and is exiting a booking segment of the travel-related website. As shown in FIG. 3, at step 200 the user has made a flight selection and exits the booking segment of the travel-related site. Once the user exits the booking segment of the website, at step 205 the exit application launches and checks if a “Do Not Show” cookie is present on the user computer 20. If this cookie is present, a booking exit window is not displayed and the process ends at step 206. If this cookie is not present on the user computer 20, at step 210 a booking exit window 350, FIG. 5, is launched on the user computer, the flight selection is coded into the booking exit window, and the booking exit window is directed to a specific web page associated with the application server and displayed on the display device 22 of the user computer 20.

If the user desires to see more information regarding the flight selected, the user selects the show flight details link at step 211. Once selected, at step 212 a detailed booking exit page is displayed in the exit window, which provides detailed information regarding the selected flight, and the user is presented with the same links discussed above.

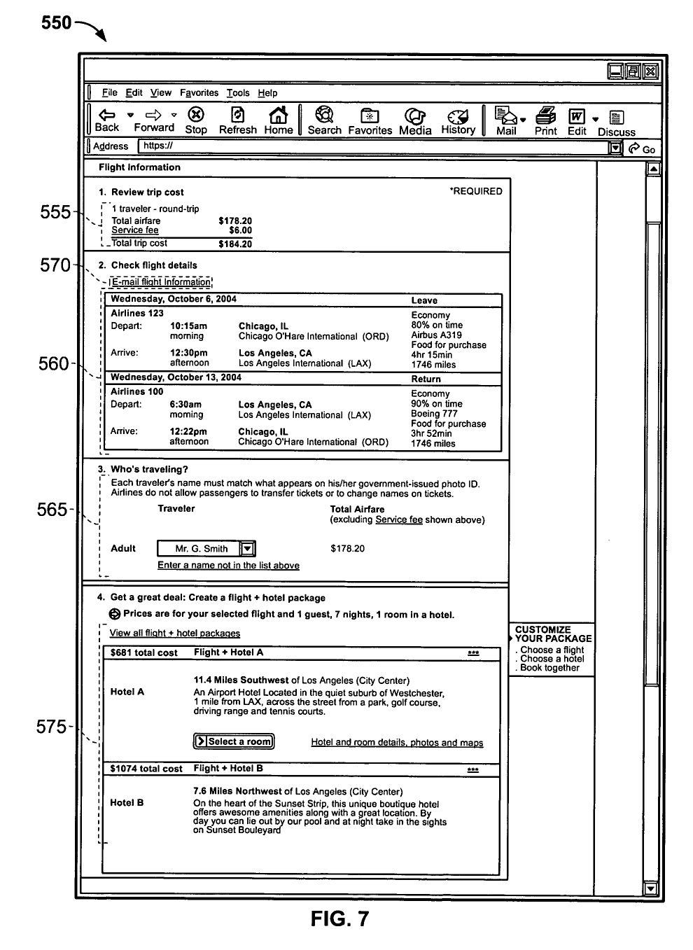

At step 215, the user selects to book the flight displayed in the exit window. Once selected, at step 216 the booking exit window is closed. At step 217, the flight selection is then re-run on the application server 30 using the search criteria saved from the earlier flight selection, which is saved in the code of the booking exit window. At step 218, a new window is launched that is directed to the booking engine associated with the travel-related site, and information regarding the selected flight is displayed in the new window (see FIG. 7).

At step 220, the user selects to track the search results found in the search. This allows the user to request to be notified if a flight becomes available that satisfies the search criteria and has a price that either is below the current price or below a price set by the user. Once selected, at step 222 the search exit window is closed. At step 224, a new window is launched, is directed to a track search page on the travel-related site, and the track search page is displayed in the new window (see FIG. 14).

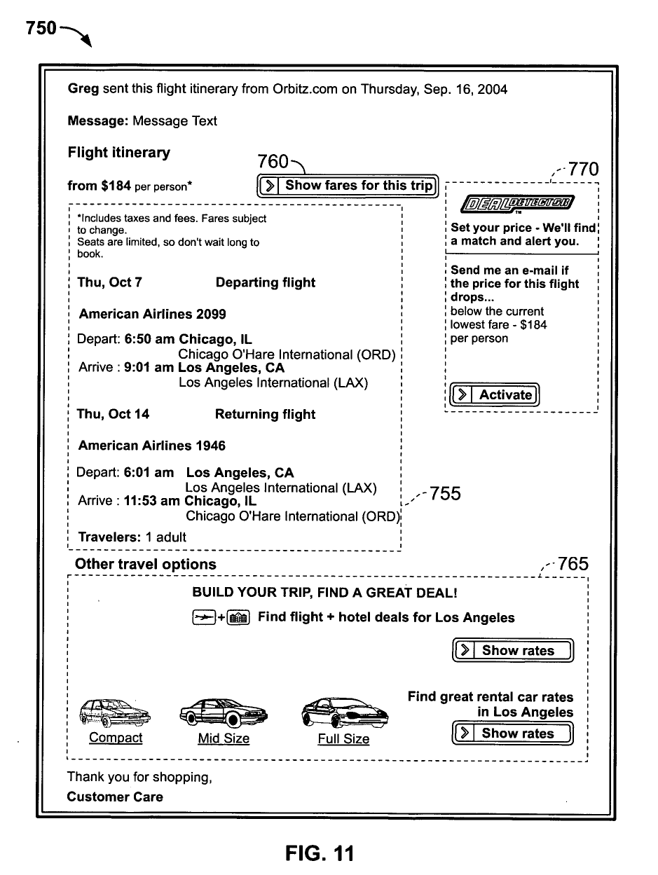

At step 225, the user selects to email the itinerary (for the selected flight) to others. Once selected, at step 226 an email address input screen is displayed in the booking exit window. If the user changes their mind, they can cancel out of the email address input screen at which time the booking exit page would again be displayed in the booking exit window. If the user does not cancel out of the email address input screen, the user enters the information required on in the email address input screen and submits the information at step 227. This information is sent to the application server 30 and at step 228 it is determined if a value has been entered into each required field and if the values are formatted correctly. If values have been entered into each required field and the values are formatted correctly, at step 229 an email is sent by the application server 30 (see FIG. 11) and the booking exit page is again displayed in the booking exit window. If values are not entered into each required field or values are formatted incorrectly, at step 230 an email address error screen is displayed in the booking exit window and the user is requested to enter the missing values or correct or re-enter the incorrectly formatted values, at which point the user would again cancel or enter and submit the values (step 227).

At step 235, the user selects a cross-sell product deal link, which allows the user to view results for other travel-related products, such as hotels, cars, packages, etc., based on the user inputted search criteria associated with the original flight selected. Once selected, at step 236 the booking exit window is closed. At step 237, a search is run on the application server 30 for the cross-sell product using the earlier flight selection, which is saved in the code of the booking exit window. At step 238, a new window is launched, is directed to the travel-related site, and the cross-sell product search results are displayed in the new window.

At step 240, the user selects to “turn off” the booking exit window, which allows the user to prevent the booking exit window from appearing in the future when the user exits the travel-related site for any reason. Once selected, at step 241 a “Do Not Show” cookie is set on the user computer with instructions not to launch the booking exit window in the future (see step 205 above) and the booking exit window is then closed at step 250. At step 245, the user selects to close the booking exit window, which closes the booking exit window at step 250.

FIG. 4 shows an exemplary search exit window 300, which contains a summary 305 of the search criteria that was used to perform the last search done before the travel-related website was exited, which is saved in the code of the search exit window 300. In the example seen in FIG. 4, the last search performed was for flights from Chicago, Ill. to Los Angeles, Calif. leaving on Sep. 6, 2004, and returning on Sep. 13, 2004. In addition, there is a selectable return link provided in this example as an actuatable link 310, which could be hyperlinked text or a button or other graphic. Selection of actuatable link 310 will initiate a re-execution of a search on the travel-related website using the previously inputted search criteria (including criteria shown in the summary 305) and saved in the code of the search exit window 300. Selection of the actuatable link 310 will take the user back to the travel-related website associated with the application server to show the results of the search without the user having to re-enter the search criteria.

In addition to the summary 305 and actuatable search link 310, the search exit window 300 may also contain other modules or links that will assist the user or allow the travel-related site to promote additional products or services. For example, the search exit window 300, FIG. 4, contains an email itinerary link 315, which would give the user the ability to email the search results performed by the user to themselves and/or others, such as family or friends.

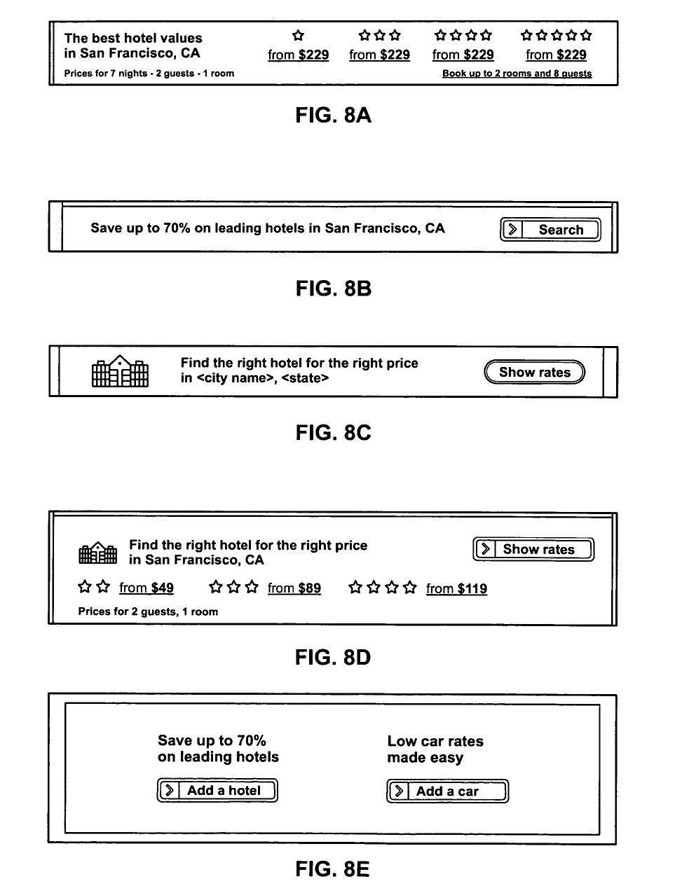

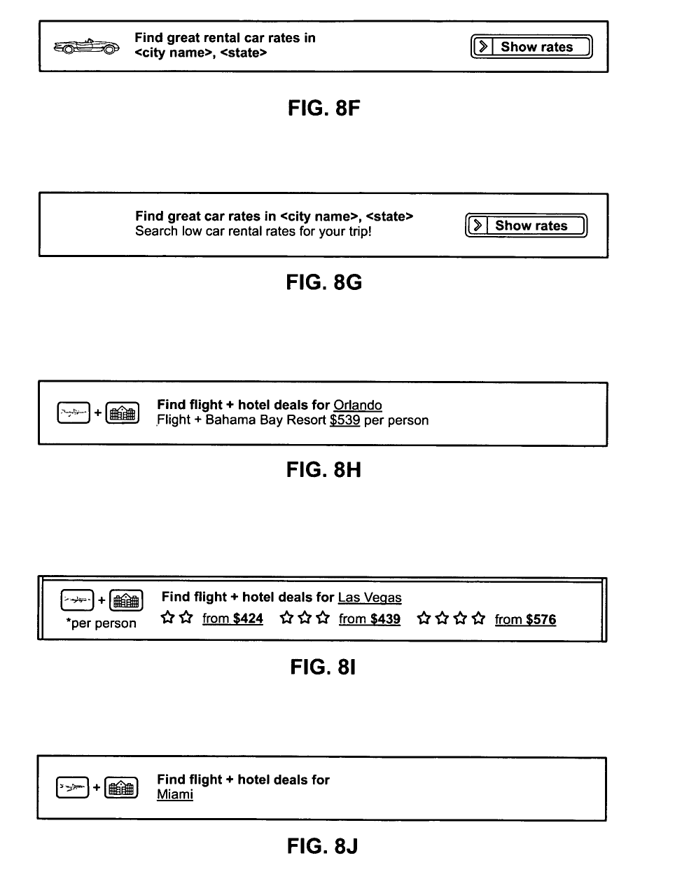

The search exit window 300 may also selectively contain a cross-sell module 320. The cross-sell module 320 can display other products or packages that the user may be interested in based on the search criteria and provide a link, such as hypertext, button or a graphic link that would allow the user to view more information regarding those products or packages or both. For example, in FIG. 4, given that the last search performed by the user was for flights from Chicago to Los Angeles, the cross-sell module 320 has displayed a possible flight and hotel package deal that may be available for this trip and provided a link 321 to allow the user to view these package deals. As shown in FIGS. 8A-G, the cross-sell module could also display other products that the user may be interested in, such as hotels (FIGS. 8A-E), rental cars (FIGS. 8E-G) or attractions (e.g. skiing, tours, etc., not shown), and provide links that would allow the user to obtain more information regarding these products. In addition, a combination of products and/or packages could be displayed. For example, the cross-sell module 320 could display a package deal (FIG. 8H-J) and provide links to each of these products allowing the user to decide which one they are interested in.

The search exit window 300 may also selectively contain an advertising module 325. The advertising module 325 can be a banner add, text add, graphic, or any other type of advertising for the travel-related site or for anything else desired. In addition, the advertising module could have a link that would take the user to the website of the entity advertised or to any other website.

The search exit window 300 may also selectively contain a track search link 330. The track search link 330 provides a link to a service that will allow the user to track the search they have performed to determine when the product drops below a desired price. For example, in FIG. 4, the user would be able to track flights from Chicago to Los Angeles and be notified when the price of these flights drops below a price entered by the user or below the price at the time of the initial search.

The search exit window 300 may also selectively contain a customer service module 335, which provides a customer service or telesales phone number that the user can call to obtain assistance. The customer service module 335 may include static text or graphics or it could be dynamic and be determined by the product being searched by the user or the products/packages displayed in the cross-sell module 320. For example, if the user performs a search for flights and the summary 305 is showing flight search information, the phone number displayed in the customer service module 335 may selectively be the flight customer service number. However, if the user performs a search for hotels and the summary 305 is showing hotel information, the phone number displayed may selectively be for a hotel flight customer service. Similarly, if a flight and hotel package deal is displayed in the cross-sell module 320, the phone number displayed in the customer service module 335 may selectively be the packaging customer service number.

The search exit window 300 also contains a close exit window link 340. Selection of the close exit window link prompts closing of the search exit window 300. The search exit window 300 further contains a “turn off” exit window link 345. Selection of the “turn off” exit window link sets a cookie on the user computer 20 with instructions not to launch any more exit windows and then close the search exit window 300.

FIG. 5 shows an exemplary booking exit window 350, which contains a summary 355 of the flight selection made before the travel-related website was exited, which is saved in the code of the booking exit window 350. In the example seen in FIG. 5, the flight selection was for a non-stop flight from Chicago, Ill. to Los Angeles, Calif. leaving on Oct. 6, 2004, at 10:15 am and returning on Oct. 13, 2004, at 6:30 am. In addition, there is abooking link 360, which may selectively be hyperlinked text or a button or other graphic, that will take the user back to a booking engine via the application server 30 on the travel-related site to allow the user to complete the booking of the flight without the user having to re-enter the flight information.

In addition to the summary 355 and booking link 360, the booking exit window 350 may also selectively contain other modules or links as described above for the search exit window 300 that will assist the user or allow the travel-related site to promote additional products or services, such as an email itinerary link 365, a cross-sell module 370, an advertising module 375, a track search link 380, a customer service module 385, a close exit window link 390, or a “turn off” exit window link 395. In addition, the booking exit window 350 may also contain a show flight details link 367, which would provide additional detail regarding the flight displayed in the summary 355.

FIG. 6 shows an exemplary search result page 500 from the travel-related site showing the results of a search performed for flights from Chicago, Ill. to Los Angeles, Calif. The search result page 500 contains a search result summary 505 and a detailed summary 510. The search result summary 505 displays the results of the search in a tabular format. The columns of the table identify the airlines, or other product provider, that were found in the search, the rows identify the type of product (i.e. number of stops for flights, types of rooms for hotels, size of car for cars, etc.), and the cells at the intersection of the columns and rows identify the prices found in the search for the particular product identified from the provider identified. The cells at the intersection of the columns and rows could also provide links to more detailed information regarding the product identified from the provider identified. The detailed summary 510 displays the details of each individual flight found in the search. In addition, there is a booking link 515 associated with each individual flight shown in the detailed summary 510 to allow the user to book the flight(s) displayed.

As described above for the search and booking exit windows, the search result page 500 may also selectively have: a cross-sell module 530, which allows the travel-related site to display additional products or packages based on the search criteria and the user to obtain additional information on the products or packages; a track search link 535, which provides a link to a service that will allow the user to track the search they have performed to determine when the product has price that either is below the current price or below a price set by the user; or an advertising module 540, which can be embodied in a banner add, text add, graphic, or any other type of advertising for the travel-related site or for anything else desired.

The search result page 500 may also have a change search module 545, which displays the search criteria used for the last search and allows the user to quickly and easily change certain parameters, such as the dates of travel, and easily re-run the search with the changed parameters without having to start over and re-enter all of the search criteria.

FIG. 7 shows an exemplary flight booking window 550. The flight booking window 550 is displayed when a user selects a flight to book and provides the user with a summary of the cost of the flight 555 and the details of the flight 560 and requests information regarding the individuals traveling 565. Similar to the search and booking exit windows described above, the flight booking window 550 may also include an email itinerary link 570, which would allow the user to email the flight information to themselves and/or others, or a cross-sell module 575, which would allow the travel-related site to display additional travel-related products or packages based on the flight selected by the user or links for the user to obtain additional information on these additional products or packages.

FIGS. 8A-J show exemplary cross-sell modules that can be used to display information for various travel-related products and/or packages and provide links to allow users to obtain additional information regarding the products and/or packages. For example, the cross-sell modules in FIGS. 8A-D could be used to alert a user to hotel deals available, FIG. 8E could be used to alert the user to both hotel deals and car deals that are available, FIGS. 8F-G could be used to alert the user to car deals that are available, and FIGS. 8H-J could be used to alert the user to flight and hotel package deals that are available. These cross-sell modules could be used individually or could be combined to alert the user to multiple or various products or packages that are available.

FIG. 9 shows an exemplary email address input screen 600. The email address input screen 600 contains: (1) a name field 605, for the user to input their name; (2) an address field 610, for the user to input the emails address(es) of the recipient(s); and (3) a message field 615, for the user to input an optional message. The email address input screen 600 also contains a cancel link 620, which allows the user to exit the email address input screen 600 without sending the email, and a send mail link 625, which allows the user to send the email based on the information entered.

FIG. 10 shows an exemplary email 700 that is sent from the email address input screen 600 or email address error screen 650 if the user has sent the email from the search exit window 300. The email 700 contains a summary 705 of the search criteria from the last search performed by the user. In addition, there is a search link 710, which could be hyperlinked text or a button or other graphic, that will re-run a search on the travel-related site using the criteria shown in the summary 705 and take the email recipient to the travel-related site to show the results of the search without the recipient having to re-enter the search criteria.

The email 700 may also contain a cross-sell module 715. The cross-sell module 715 can display other products or packages that the recipient may be interested in based on the search criteria and provide a link, such as hypertext or a graphic link that would allow the recipient to view more information regarding those products or packages. The email 700 may also contain a track search link 720 that provides a link to a service that will allow the recipient to track the search received in the email to determine when the product drops below a desired price.

FIG. 11 shows an exemplary email 750 that is sent from the email address input screen 600 or email address error screen 650 if the user has sent the email from the booking exit window 350. The email 750 contains a summary 755 of the flight chosen by the user before the travel-related site was exited. In addition, there is a booking link 760, which may selectively be hyperlinked text or a button or other graphic that will send the recipient to the booking engine on the travel-related site and display the information for the flight selection displayed in the summary 755.

The email 750 also contains a cross-sell module 765 that displays other products or packages that the recipient may be interested in based on the flight selection and provide a link, such as hypertext or a graphic link that would allow the recipient to view more information regarding those products or packages. The email 750 also has a track search link 770 that provides a link to a service that will allow the recipient to track the flight received in the email to determine when the flight has a price that either is below the current price or below a price set by the user.

FIG. 12 shows an exemplary search result page 800 from the travel-related site showing the results of a search performed for flight and hotel packages. The search result page 800 contains a search result summary 805. The search result summary 805 displays the results of the search in a tabular format. The columns of the table identify the airlines and number of stops for the identified flights that were found in the search, the rows identify the hotel and the location of the hotel, and the cells at the intersection of the columns and rows identify the prices found in the search for the particular combination of flight and hotel. The cells at the intersection of the columns and rows also provide links to more detailed information regarding the package identified.

The search result page 800 also has a change search module 820, which displays the search criteria used for the last search and allows the user to quickly and easily change certain parameters, such as the dates of travel, and easily re-run the search with the changed parameters without having to start over and enter all of the search criteria.

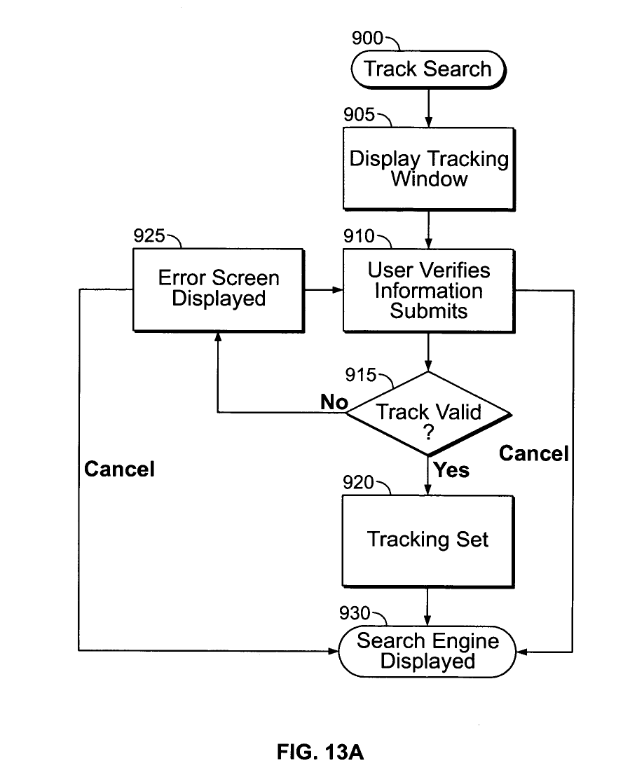

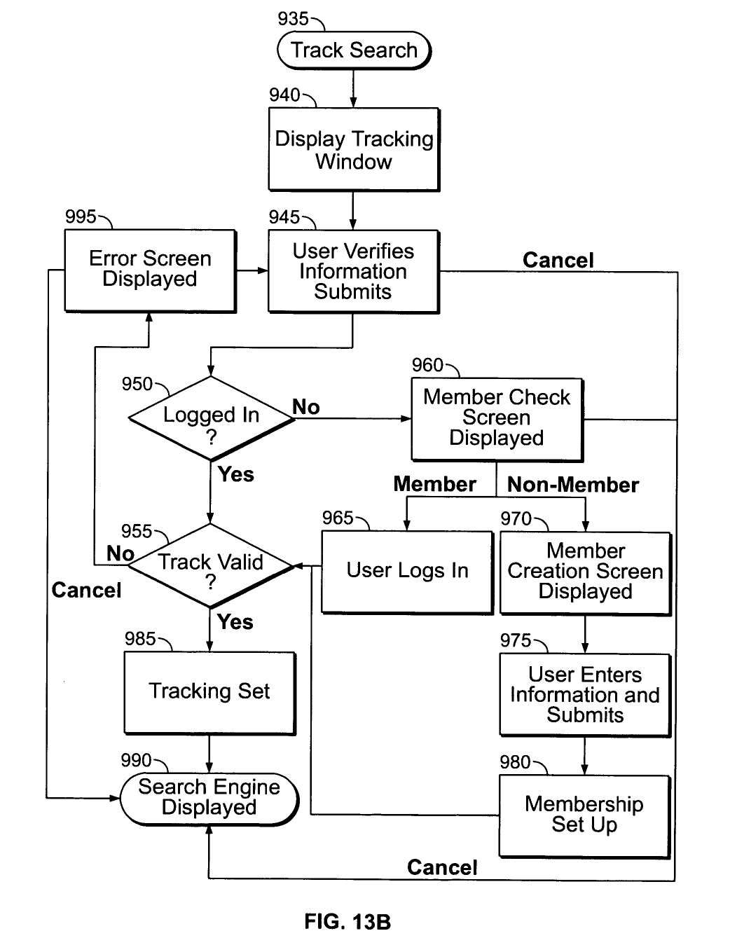

FIG. 13A illustrates how the track search option operates once a user has chosen to track a travel-related product. As shown in FIG. 13A, at step 900, the user chooses to track a travel-related product. At step 905, a display tracking window launches and is displayed on the user computer 20 (see FIG. 14). The display tracking window 1000 shows the information from the last search performed or the last travel-related product chosen, such as the destination, travel dates, number of travelers, etc., and allows the user to review and change the information and set a price that the user is willing to pay.

At step 910, the user verifies that the information displayed is correct, or makes the changes desired, enters the target price desired, and submits the information. In addition, rather than submitting the information, the user can cancel the request in which case the user is returned to the search engine or booking engine via the application server 30 in step 930.

At step 915, the travel-related website receives the information submitted by the user and validates the information. If the information submitted is valid, the travel-related site sets the requested tracking at step 920 and the user is returned to the search engine 40 or booking engine via application server 30 at step 930. If the information submitted is not valid, an error screen is displayed on the user computer 20 at step 925 and the process continues with the user again verifying the information in step 910 or re-enter the incorrectly formatted values, at which point the user may again cancel or enter and submit the values.

FIG. 13B illustrates how the track search option works on a membership based program once a user has chosen to track a travel-related product. As shown in FIG. 13B, at step 935, the user chooses to track a travel-related product. At step 940, a display tracking window launches and is displayed on the user computer 20 (see FIG. 14). The display tracking window shows the information from the last search performed or the last travel-related product chosen, such as the destination, travel dates, number of travelers, etc., and allows the user to review or change the information and set a price that the user is willing to pay.

At step 945 the user verifies that the information displayed is correct, or makes the changes desired, enters the target price desired, and submits the information. In addition, rather than submitting the information, the user can cancel the request in which case the user is returned to the search engine or booking engine in step 990.

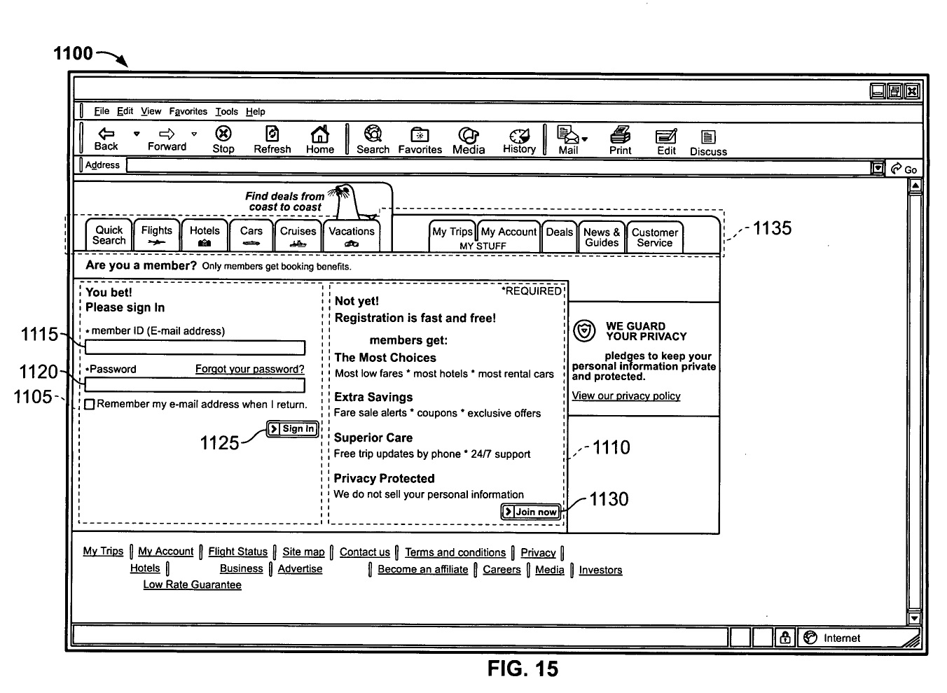

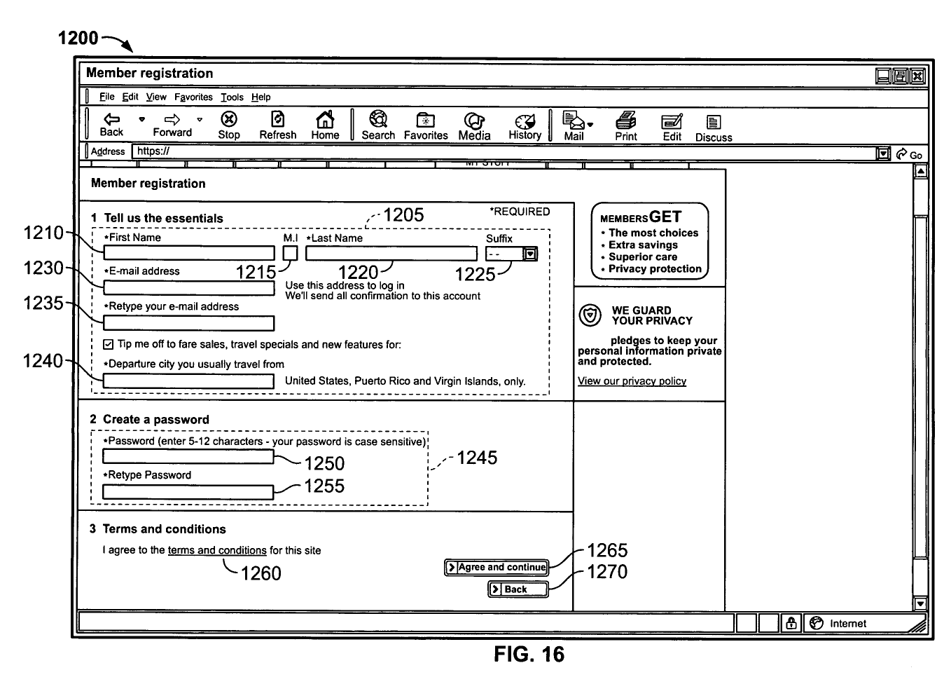

At step 950, the travel-related website receives the information submitted by the user and determines if the user is logged onto the site. If the user is logged onto the site, the process continues with step 955. If the user is not logged onto the site, at step 960 a member check screen is displayed (see FIG. 15), which requests that the user either log onto the site or, if the user is not already a member, that the user create a membership. If the user is a member, the user logs onto the site at step 965 and the process continues with step 955. If the user is not a member, at step 970 a member creation screen is displayed (see FIG. 16), which requests that the user enter various information to create a membership. At step 975, the user enters and submits the requested information. The membership is then set up at the site at step 980 and the process continues with step 955.

At step 955, the travel-related site validates the information submitted. If the information submitted is valid, the travel-related site sets the requested tracking at step 985 and the user is returned to the search engine or booking engine at step 990. If the information submitted is not valid, an error screen is displayed on the user computer at step 995 and the process continues with the user again verifying the information in step 945.

FIG. 14 shows an exemplary display tracking window 1000. The display tracking window 1000 contains: (1) a travel destination summary 1005, which displays the destinations from the search criteria and allows the user to change the destinations if they wish; (2) a travel date summary 1010, which displays the travel dates from the search criteria and allows the user to change the travel dates if they wish; (3) a traveler summary 1015, which displays the number of travelers in each traveler category and allows the user to change the number of travelers or the number of travelers in each category if they wish; and (4) a target price module 1020, which allows the user to chose if they want to track the travel-related product until the price drops below the current price or until the price drops below a price entered by the user. The display tracking window 1000 also contains a cancel link 1030, which may selectively be hyperlinked text or button or other graphic, that allows the user to exit the display tracking window 1000 without submitting the tracking request, and a submit request link 1035, which may selectively be hyperlinked text or button or other graphic, that allows the user to submit the tracking request based on the information entered.

FIG. 15 shows an exemplary member check screen 1100, which contains a members section 1105 and a non-members section 1110. The members section 1105 allows members of the travel-related site to log onto the site and contains a member ID field 1115, which allows the user to enter their member ID, a password field 1120, which allows the user the enter their password, and a sign in link 1125, which may selectively be hyperlinked text or button or other graphic, that submits the information entered by the user to the travel-related site. The non-members section 1110 allows non-members to join the travel-related site and contains a join link 1130, which may selectively be hyperlinked text or button or other graphic, that directs the user to a member creation screen (see FIG. 16) to create a membership.

FIG. 16 shows an exemplary member creation screen 1200 where a user can create a membership on the travel-related site. The member creation screen 1200 has a member information section 1205 that contains fields for the user to enter their: (1) first name 1210; (2) middle initial 1215; (3) last name 1220; (4) name suffix 1225; (5) email address 1230; (6) email address confirmation 1235; (7) and usual departure city 1240. The member creation screen 1200 also has a password section 1245 that contains a password field 1250, where the user can enter a password of their choosing, and a password confirmation field 1255, where the user will retype their password to verify that there was no mistake in the password entered in the password field. The member creation screen 1200 also contains a back link 1270, which may selectively be hyperlinked text or button or other graphic, that will direct the user back to the member check screen 1100, and an agree and continue link 1265, which allows the user to submit the membership information entered to create the membership. The member creation screen 1200 also includes a terms and conditions link 1260, which will direct the user to a different screen where they could view the terms and conditions for being a member of the travel-related site.

The exit application assumes that a user may need to return to the travel-related site within a reasonable amount of time and intends to search again for the same or similar product. It saves time: the customer returns to the travel-related site at a point where they left without starting over and re-entering search criteria. It provides shortcut access by providing one-click access to several product features (i.e. search tracking, shop for package deals, providing advertising for others, shopping for other products such as flights, hotels, car rentals, attractions, etc.).

The exit window holds the searched information so the customer can easily return to the site. The exit window enables the customer to obtain current search results or current pricing/availability on a specific itinerary, track the trip for changes in pricing, obtain search results for other travel-related services such as hotels, cars, or packages, etc.

Once the customer attempts to navigate off of the travel-related site by closing the browser, entering a new URL address, or selecting a favorites link (confirmed also that the browser is active and the page requested is not hosted by the travel-related site), then exit window is created and displayed to the customer. This exit window contains several links and text to enable the customer to easily return to the travel-related site.

The foregoing description of the preferred embodiments of the invention have been presented for purposes of illustration and description, and are not intended to be exhaustive or to limit the invention to the precise forms disclosed. The descriptions were selected to best explain the principles of the invention and their practical application to enable other skills in the art to best utilize the invention in various embodiments and various modifications as are suited to the particular use contemplated. It is intended that the scope of the invention not be limited by the specification, but be defined by the claims set forth below.

What is claimed is:

1. A computer implemented system for automatically providing a window for display on a display device coupled with a user computer comprising:
an application server that receives inputted search criteria obtained by user interaction with a website; and
at least one web page of the website associated with an exit window application component that is adapted to launch an exit window, the exit window comprising information related to the search criteria, for display on the display device in response to a determination that the website is being exited.

2. The system of claim 1 in which the exit window application component comprises code associated with information related to the search criteria.

3. The system of claim 1 further comprising a selectable return link in the exit window.

4. The system of claim 3 further comprising a search engine coupled with the application server.

5. The system of claim 4 in which the exit window is adapted to be closed and to initiate a display of search results based on information related to the search criteria in a search results window in response to selection of the selectable return link.

6. The system of claim 4 in which the exit window application component launches the exit window in response to at least one of: (a) entering a new URL at the user computer, (b) selecting a link to an external website, and (c) closing a browser window associated with the website.

7. The system of claim 6 in which the exit window application component receives a command from the browser window in response to either (a), (b) or (c).

8. The system of claim 7 in which the exit window application component comprises code to prevent the launch of the exit window in response to selection of an internal link.

9. The system of claim 7 in which the exit window application component comprises code to close the exit window in response to a determination that the website has not been exited.

10. The system claim 2 in which the search criteria is for a travel-related product.

11. The system of claim 10 in which the travel-related product includes at least one of (a) airline flights, (b) hotel accommodations, (c) car rentals and (d) travel packages.

12. The system of claim 11 in which the search criteria relates to airline flights and the exit window includes a summary of the last search criteria received for the airline flights.

13. The system of claim 12 further comprising an e-mail itinerary link displayed in the exit window.

14. The system of claim 12 further comprising a cross-sell link for initiating at least one of: (a) a hotel accommodations search, (b) a car rental search and (c) a package search based on the last search criteria in response to actuation of the cross-sell link.

15. The system of claim 12 further comprising a search tracking link displayed in the exit window.

16. A computer implemented method of automatically providing a window for display on a display device coupled with a user computer comprising:
displaying search results based on inputted search criteria through user interaction with a website;
determining if the website is being exited; and
launching an exit window, comprising information related to the search criteria, for display on the display device in response to the determination that the website is being exited.

17. The method of claim 16 further comprising saving at least a portion of the information related to the search criteria in a code associated with the exit window application component.

18. The method of claim 17 further comprising providing the exit window with at least a portion of the last search criteria inputted through user interaction with the website.

19. The method of claim 18 further comprising providing a summary of the last search criteria for display in the exit window.

20. The method of claim 17 further comprising displaying a selectable return link in the exit window.

21. The method of claim 20 further comprising receiving an instruction that the selectable return link has been selected;
closing the exit window in response to receipt of the instruction; and
displaying search results based on the information related to the search criteria saved in the code associated with the exit window application component.

22. The method of claim 21 further comprising launching a search results window; and
displaying the search result in the search results window.

23. The method of claim 17 in which the step of determining further comprises determining at least one of: (a) that a new URL has been entered at the user computer, (b) that a link to an external website has been selected, and (c) that a browser window associated with the website has been closed.

24. The method of claim 23 further comprising receiving a command from the browser window in response to either (a), (b) or (c).

25. The method of claim 24 further comprising setting web pages of the website to launch the exit window upon receipt of the command from the browser window.

26. The method of claim 23 further comprising preventing a display of the exit window upon a determination that the website has not been exited.

27. The method of claim 26 in which the step of preventing further comprises coding internal links on the website to set a variable that an internal link is being followed;
coding web pages of the website to check the variable prior to launching the exit window; and
preventing display of the exit window if the variable indicates that an internal link was followed.

28. The method of claim 23 further comprising programming web pages of the website to close the exit window when one of the web pages of the website is loaded.

29. The method of claim 23 further comprising deactivating the exit window when a timeout value is reached.

30. The method of claim 17 in which the search criteria is for a travel-related product.

31. The method of claim 30 in which the travel-related product includes at least one of: (a) airline flights, (b) hotel accommodations, (c) car rentals and (d) travel packages.

32. The method of claim 31 in which the search criteria relates to airline flights and a summary of the last search criteria searched for the airline flights is displayed in the exit window.

33. The method of claim 32 further comprising displaying an e-mail itinerary link in the exit window.

34. The method of claim 32 further comprising displaying a cross-sell link in the exit window.

35. The method of claim 34 further comprising initiating at least one of: (a) a hotel accommodation search (b) a car rental search and (c) a package search based on the last search criteria in response to actuation of the cross-sell link.

36. The method of claim 32 further comprising performing a search for a cross-sell product using the information related to the search criteria saved in the code associated with the exit window application component.

37. The method of claim 32 further comprising displaying a search tracking link in the exit window.

38. The method of claim 16 in which the exit window is launched in response to a determination that the user computer is exiting a booking segment associated with a travel-related website.

39. The method of claim 38 further comprising determining that user selection of an airline flight has been made at the website; and
providing coded information related to the airline flight selection in the exit window.
